(19) United States
(12) Patent Application Publication
(10) Pub. No.: US 2008/0232944 A1
(43) Pub. Date: Sep. 25, 2008

(54) Automatic Folding Fork Device for Forklift Trucks

(76) Inventor: Seong Kyu Kim, Seoul (KR)

Correspondence Address: JORDAN AND HAMBURG LLP, 122 EAST 42ND STREET, SUITE 4000, NEW YORK, NY, 10168, US

(21) Appl. No.: 11/988,621

(22) PCT Filed: Dec. 7, 2005
(86) PCT No.: PCT/KR2005/004173

§ 371 Date: Jan. 11, 2008

(30) Foreign Application Priority Data
Jun. 16, 2005 (KR) 10-2005-0051764
Aug. 4, 2005 (KR) 10-2005-0071235

(51) Int. Cl. B66F 9/12

(52) U.S. Cl. 414/667; 414/664

(57) ABSTRACT

Disclosed herein is an automatic folding fork device for forklift trucks. The folding fork device is operated so that forks are rotated upwards and folded by the rotation of a hydraulic motor when a driver driving in a forklift truck easily manipulates a lever or switch, thus allowing the forklift truck to move safely, with the forks in a folded state. Further, this invention is constructed so that external threaded parts, having threads formed in opposite directions, are provided on both sides of the outer circumferential surface of a shaft, and coupling pipes having internal threaded parts corresponding to the external threaded parts are provided, thus allowing an interval between the forks mounted to the coupling pipes to be adjusted, according to the rotating direction of the hydraulic motor.

### TECHNICAL FIELD

The present invention relates, in general, to an automatic folding fork device for forklift trucks and, more particularly, to an automatic folding fork device for forklift trucks, which is operated so that forks are rotated upwards and folded by the rotation of a hydraulic motor when a driver driving in a forklift truck easily manipulates a lever or switch, thus allowing the forklift truck to move safely, with the forks in a folded state, and which is constructed so that external threaded parts, having threads formed in opposite directions, are provided on both sides of the outer circumferential surface of a shaft, and coupling pipes having internal threaded parts corresponding to the external threaded parts are provided, thus allowing an interval between the forks mounted to the coupling pipes to be adjusted, according to the rotating direction of the hydraulic motor.

### BACKGROUND ART

Forklift trucks are used to raise or lower goods and to move the goods to a desired place in a limited space.

As shown in FIG. 1, such a forklift truck is provided with a frame 1. Mast rails 2 are installed in front of the frame 1. Further, a carriage 2 is assembled with the mast rails 2 in such a way as to move up and down along the mast rails 2. A pair of forks 20 is mounted to the carriage 2 to support goods.

FIG. 2 shows a fork mounting structure of the forklift truck.

Upper and lower boards 12 and 14 are installed at predetermined positions on the carriage 10 in such a way as to be parallel to each other. Further, coupling boards 16 are provided on both sides of the upper and lower boards 12 and 14 to couple the upper and lower boards 12 and 14 to each other.

Assembly rails 12a and 14a are longitudinally provided on the upper surface of the upper board 12 and the lower surface of the lower board 14, respectively, so that a pair of forks 20 is movably assembled with the upper and lower boards 12 and 14. A plurality of fastening holes 18 is formed in the assembly rail 12a of the upper board 12 to fasten the forks 20 to the upper board 12.

Further, each fork 20 includes a vertical part 22, and a horizontal part 24 which extends horizontally from the lower end of the vertical part 22. An upper hook 26 and a lower hook 28 are provided, respectively, on upper and lower ends of the rear surface of the vertical part 22, and are hooked to the assembly rail 12a of the upper board 12 and the assembly rail 14a of the lower board 14, respectively.

While the forks 20 move along the upper and lower boards 12 and 14 of the carriage 10, an interval between the forks 20 is adjusted. After the interval between the forks 20 is adjusted, the forks 20 are secured to the carriage 10 via a fork fastening pin 30 which is provided on top of the vertical part 22 of each fork 20.

However, the conventional fork mounting structure is problematic in that the forks are simply hooked to the upper board 12 of the carriage 10, so that it is impossible to rotate the forks upwards and thereby fold them. Thereby, when the forklift truck runs on the road to move to another place, the forklift truck must run with the forks unfolded and pointing forwards, which is very dangerous. Further, another vehicle may be damaged by the forks of the forklift truck.

### DISCLOSURE OF INVENTION

### Technical Problem

Accordingly, the present invention has been made keeping in mind the above problems occurring in the prior art, and an object of the present invention is to provide an automatic folding fork device for forklift trucks, which is operated so that forks are rotated upwards and folded by the rotation of a hydraulic motor when a driver driving in a forklift truck easily manipulates a lever or switch, thus allowing the forklift truck to move safely, with the forks in a folded state, and which is constructed so that external threaded parts, having threads formed in opposite directions, are provided on both sides of the outer circumferential surface of a shaft, and coupling pipes having internal threaded parts corresponding to the external threaded parts are provided, thus allowing an interval between the forks mounted to the coupling pipes to be adjusted, according to the rotating direction of the hydraulic motor.

### Technical Solution

In order to accomplish the object, the present invention provides an automatic folding fork device for a forklift truck having a pair of forks mounted to a carriage which moves up and down along mast rails, wherein a shaft is inserted in and secured to a midsection of the carriage, with a fitting groove being concavely formed in an upper surface of the shaft in a longitudinal direction thereof, and a hydraulic motor is provided on a side of the carriage to rotate the shaft forwards or backwards, and a plurality of coupling pipes is secured to the shaft at regular intervals, and a ‘U’-shaped hook part is provided on an end of a vertical part of each of the forks and is hooked to an associated coupling pipe, and a fastening pin is inserted into an upper portion of the hook part to fasten each of the coupling pipes to the hook part, and a pin locking means is provided to a side of each of the coupling pipes and is provided with a locking pin which is fitted into the fitting groove by a user's manipulation.

### ADVANTAGEOUS EFFECTS

As described above, the present invention provides an automatic folding fork device for forklift trucks, which is operated so that forks are rotated upwards and folded by the rotation of a hydraulic motor when a driver driving in a forklift truck easily manipulates a lever or switch, thus allowing the forklift truck to move safely, with the forks in a folded state, and which is constructed so that external threaded parts, having threads formed in opposite directions, are provided on both sides of the outer circumferential surface of a shaft, and coupling pipes having internal threaded parts corresponding to the external threaded parts are provided, thus allowing an interval between the forks mounted to the coupling pipes to be adjusted, according to the rotating direction of the hydraulic motor.

### BRIEF DESCRIPTION OF THE DRAWINGS

FIG. 1 is a perspective view showing a general forklift truck;

FIG. 2 is a view showing a conventional fork mounting structure for the forklift truck;

FIG. 3 is a front view showing an automatic folding fork device for a forklift truck, according to an embodiment of the present invention;

FIG. 4 is a side view showing the automatic folding fork device, according to this invention;

FIG. 5 is a view showing the operation of the automatic folding fork device, according to this invention;

FIG. 6 is a partial sectional view showing important parts of this invention;

FIG. 7 is a front view showing another embodiment of the present invention;

FIG. 8 is a side view showing another embodiment of the present invention;

FIG. 9 is a view showing the operation of another embodiment of this invention;

FIG. 10 is a partial sectional view showing a first locking means adapted to another embodiment of this invention;

FIG. 11 is a sectional view showing the locked state of the first locking means adapted to another embodiment of this invention;

FIG. 12 is a sectional view showing a second locking means adapted to another embodiment of this invention; and

FIGS. 13 and 14 are views showing a wire connection, according to another embodiment of the present invention.

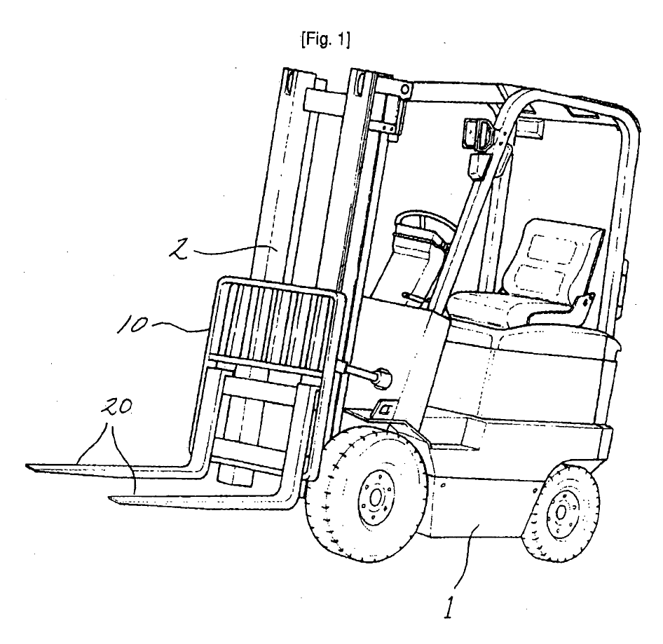

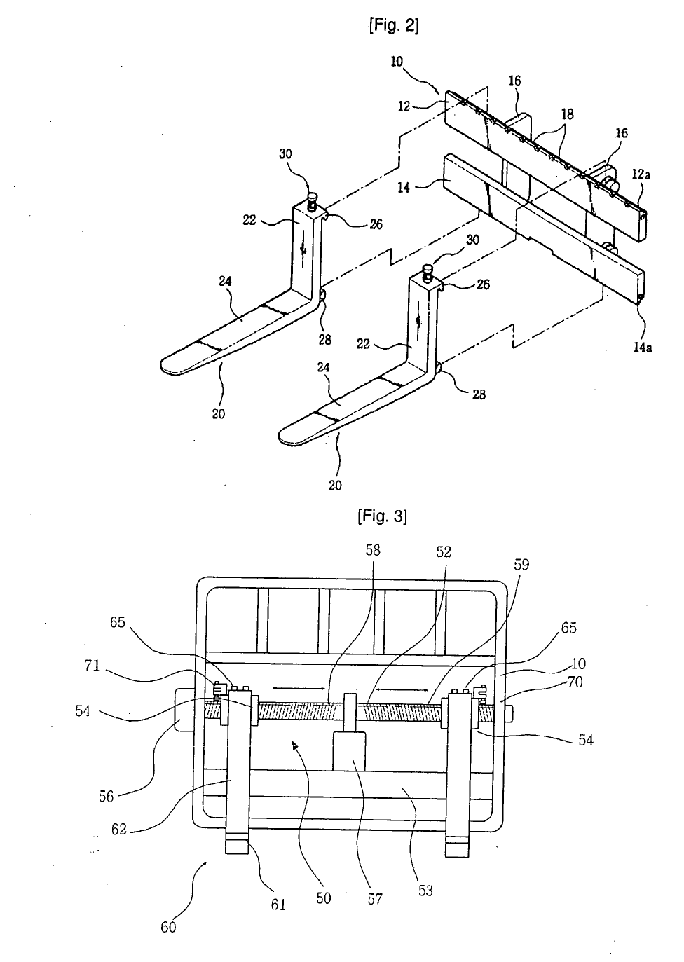

### MODE FOR THE INVENTION

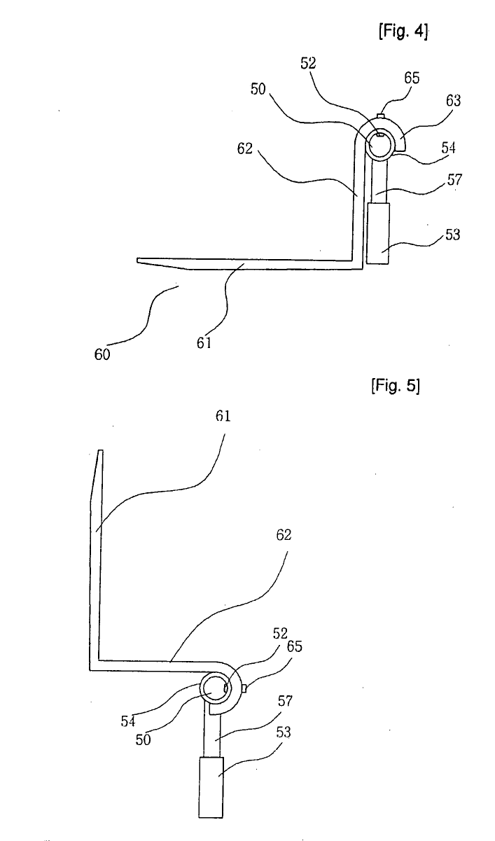

Hereinafter, the preferred embodiment of the present invention will be described with reference to FIGS. 3 to 6.

Those elements common to both the prior art and the present invention will carry the same reference numerals. The common elements will not be described below.

Reference numeral 10 denotes a carriage, with a pair of forks 60 hooked to the carriage 10.

A shaft 50, having a circular cross-section and a predetermined length, is horizontally inserted into a middle portion of the carriage 10 in such a way as to be rotatable. A fitting groove 52 is concavely formed in the upper surface of the shaft 50 in a longitudinal direction thereof. A lower board 53 is provided under the shaft 50 to support the lower portions of the forks 60.

Further, a hydraulic motor 56 is mounted to a side of the carriage 10 to rotate the shaft 50 forwards or backwards. The central portion of the lower board 53 is coupled to the central portion of the shaft 50 via a central support part 57. The upper portion of the central support part 57 is mounted so as to surround the central portion of the shaft 50, so that the central support part 57 supports the shaft 50.

Meanwhile, coupling pipes 54 are mounted to both sides of the shaft 50. A pin insertion recess 64a is provided on the upper surface of each coupling pipe 54 so that a fastening pin 65, which will be described later, is inserted into the pin insertion recess 64a. A pin locking means 70 is provided at a predetermined position on the upper end of each coupling pipe 54 to lock the coupling pipe 54 to the shaft 50.

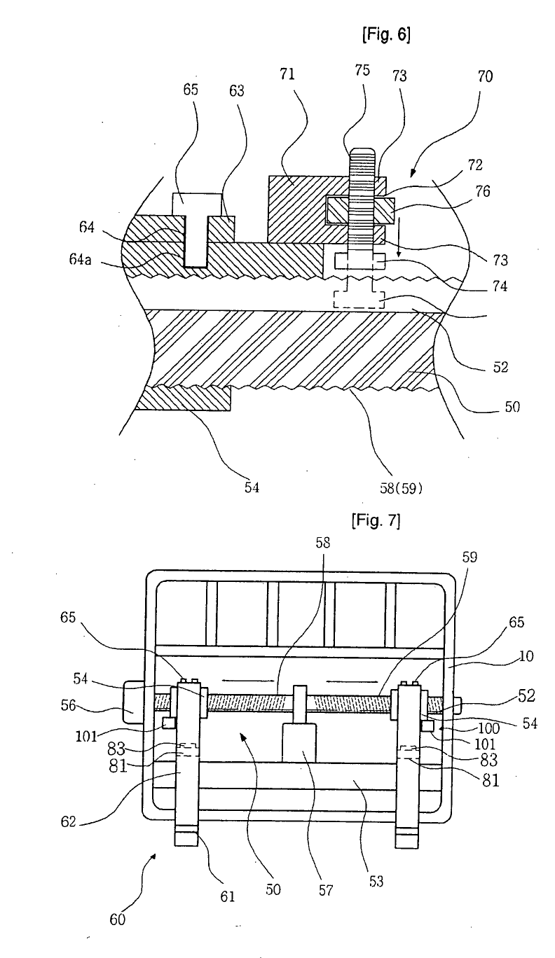

As shown in FIG. 6, the pin locking means 70 includes a housing 71. The housing 71 having a ‘U’-shaped cross-section is mounted to the upper end of one side of each coupling pipe 54. Pin locking ribs 73 are provided on upper and lower portions of the housing 71, with a nut mounting space 72 formed between the pin locking ribs 73. A pin shank 75 of a locking pin 74 is inserted into the pin locking ribs 73 in a direction from a lower position to an upper position, so that the locking pin 74 is positioned right above the fitting groove 52 which is formed in the upper surface of the shaft 50.

Further, an adjusting nut 76 is fitted over the midsection of the pin shank 75 to be located in the nut mounting space 72. As a user rotates the adjusting nut 76, the pin shank 75 moves up and down, so that the locking pin 74 is selectively inserted into the fitting groove 52.

When the locking pin 74 is inserted into the fitting groove 52, each coupling pipe 54 is rotated by the rotation of the shaft 50.

Meanwhile, as shown in the drawings, each fork 60 includes a horizontal part 61 and a vertical part 62. A hook part 63 which is bent in a ‘U’ shape is provided on an end of the vertical part 62 to be hooked to the corresponding coupling pipe 54. A pin hole 64 is formed in the upper portion of the hook part 63 so that the fastening pin 65 is inserted into the pin hole 64.

Thus, the hook part 63 of each fork 60 is hooked to the corresponding coupling pipe 54 which is fitted over the shaft 50. In such a state, the fastening pin 65 is fitted into the pin hole 64 to be inserted into the pin insertion recess 64a which is provided on the upper surface of each coupling pipe 54. Thereby, the fork 60 is fastened to the corresponding coupling pipe 54.

In the present invention constructed as described above, a user rotates the adjusting nut 76 of the pin locking means 70 so that the locking pin 74 is fitted into the fitting groove 52 of the shaft 50. In such a state, the hydraulic motor 56 is rotated at 90 degrees. Then, the shaft 50 is rotated at 90 degrees by the driving of the hydraulic motor 56, so each coupling pipe 54, locked to the shaft 50 via the locking pin 74, is also rotated. Thereby, as shown in FIG. 5, each fork 60 rotates at 90 degrees along with the shaft 50, so that the forks 60 are folded to face upwards.

As described above, when each fork 60 is rotated at 90 degrees to be folded upwards, the forklift truck may run on the road with the forks 60 folded toward the sky, thus safety is ensured.

Meanwhile, according to this invention, it is possible to adjust the interval between the forks 60 which are hooked to the shaft 50.

To this end, external threaded parts 58 and 59 are formed on both sides of the outer circumferential surface of the shaft 50 such that threads of the external threaded parts 58 and 59 are formed in opposite directions. An internal threaded part 55 corresponding to the external threaded part 58, 59 is provided on the inner circumferential surface of each coupling pipe 54 which is fitted over the shaft 50. When the shaft 50 is rotated in one direction by the rotation of the hydraulic motor 56, the interval between the coupling pipes 54 fastened to the shaft 50 is increased or decreased, so that the interval between the forks 60 is automatically adjusted.

That is, the external threaded parts 58 and 59 are formed on the outer circumferential surface of the shaft 50 in opposite directions. Thus, when the shaft 50 rotates in one direction, the interval between the two coupling pipes 54 fitted over the shaft 50 is increased or decreased, so that the interval between the forks 60 is adjusted.

In such a forklift truck, the forks are the weakest part. The present invention uses an elbow structure which has been widely applied to the forklift truck so as to ensure safety, thus affording safety. Unlike the conventional forklift truck which is constructed so that a hook part is welded to an end of the vertical part of each fork, the present invention is constructed so that the hook part provided on an end of the vertical part of each fork is bent in a ‘U’ shape, so that greater safety and strength are ensured.

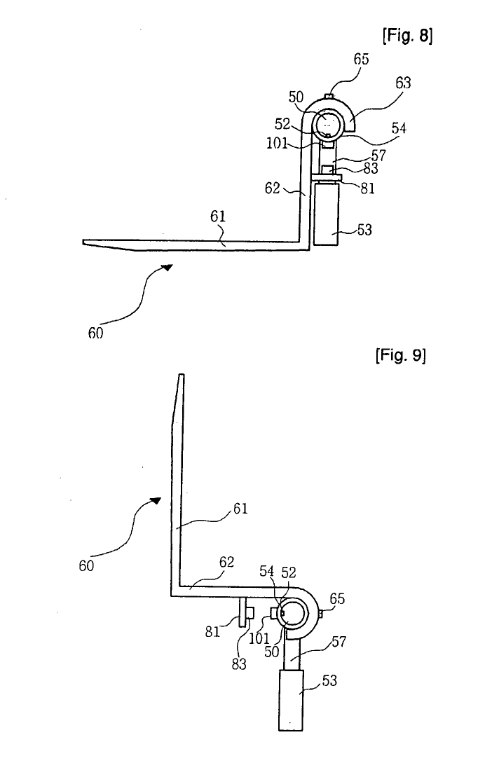

FIGS. 7 to 14 show another embodiment of the present invention. This embodiment will be described below with reference to the accompanying drawings.

The elements common to both embodiments of this invention will carry the same reference numerals. The common elements will not be described below.

Reference numeral 10 denotes a carriage, with a pair of forks 60 hooked to the carriage 10.

A shaft 50, having a circular cross-section and a predetermined length, is horizontally inserted into a middle portion of the carriage 10 in such a way as to be rotatable. A fitting groove 52 is concavely formed in the outer circumferential surface of the shaft 50 in a longitudinal direction thereof. A lower board 53 is provided under the shaft 50 to support the lower portions of the forks 60.

Further, a hydraulic motor 56 is mounted to a side of the carriage 10 to rotate the shaft 50 forwards or backwards. The central portion of the lower board 53 is coupled to the central portion of the shaft 50 via a central support part 57. The upper portion of the central support part 57 is mounted so as to surround the central portion of the shaft 50, so that the central support part 57 supports the shaft 50.

Meanwhile, coupling pipes 54 are mounted to both sides of the shaft 50. A pin insertion recess 64a is provided on the upper surface of each coupling pipe 54 so that a fastening pin 65, which will be described later, is inserted into the pin insertion recess 64a.

Meanwhile, as shown in the drawings, each fork 60 includes a horizontal part 61 and a vertical part 62. A hook part 63 which is bent in a ‘U’ shape is provided on an end of the vertical part 62 to be hooked to the corresponding coupling pipe 54. A pin hole 64 is formed in the upper portion of the hook part 63 so that the fastening pin 65 is inserted into the pin hole 64.

Thus, the hook part 63 of each fork 60 is hooked to the corresponding coupling pipe 54 which is fitted over the shaft 50. In such a state, the fastening pin 65 is fitted into the pin hole 64 to be inserted into the pin insertion recess 64a which is provided on the upper surface of each coupling pipe 54. Thereby, the fork 60 is fastened to the corresponding coupling pipe 54.

Further, a first locking means 100 is provided on one side of each coupling pipe 54 to lock the coupling pipe 54 to the shaft 50, thus permitting the folding of each fork 60.

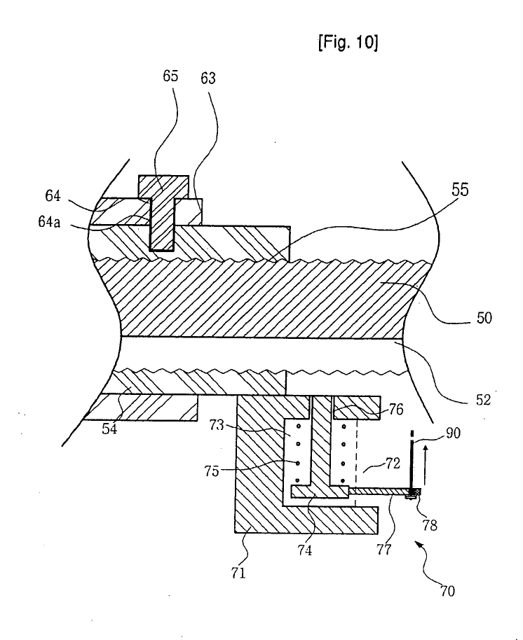

As shown in FIG. 10, the first locking means 100 has a housing 101 on one side of the lower end of each coupling pipe 54. A pin receiving space 103 is defined in the housing 101 to receive a first locking pin 104. A pin hole 106 is formed above the pin receiving space 103, and a slit 102 is vertically formed at a predetermined position on the housing 101. The first locking pin 104 is provided in the housing 101 to be biased by a return spring 105 in the direction in which the pin moves away from the fitting groove 52.

Further, a wire connection bar 107 having a predetermined length protrudes from one side of the locking pin 104, and protrudes through the slit 102 out of the housing 101. A wire 90, connected to a manipulating lever 93 installed in a driver's seat, is connected to the wire connection bar 107.

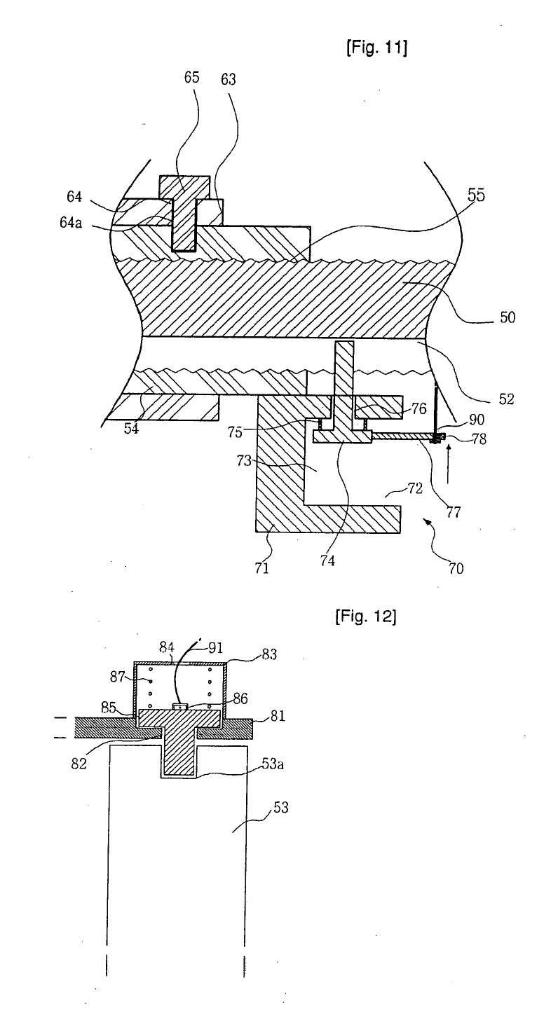

Thus, at normal times when the wire 90 is not pulled, that is, when the forks 60 are not folded, as shown in FIG. 6, the first locking pin 104 is removed from the fitting groove 52 by the elasticity of the return spring 105, so that the fork 60 is not folded. Meanwhile, when a user manipulates the manipulating lever 93 provided on the driver's seat and pulls the wire 90, as shown in FIG. 11, the first locking pin 104 overcomes the elasticity of the return spring 105 and moves upwards, thus being fitted into the fitting groove 52. Thereby, each fork 60 is rotated upwards and folded by the rotation of the shaft 50.

Further, according to this invention, a second locking means 80 is provided to prevent each fork from being shaken, moved, or dislodged when the fork 60 is opened and used.

The second locking means 80 has a horizontal bar 81 having a predetermined length. The horizontal bar 81 is provided on the vertical part 62 of each fork 60, that is, the rear surface of the midsection of the vertical part 62, to be disposed above the lower board 53. A cover 83 having a wire outlet hole 84 protrudes from the upper surface of the horizontal bar 81. A predetermined space is defined in the cover 83, and a pin hole 82 is formed in the horizontal bar 81 such that the second locking pin 85 passes through the horizontal bar 81.

Further, the second locking pin 85 is provided inside the cover 82 in such a way as to be elastically biased downwards by a return spring 87. A locking hole 53a is formed in the upper surface of the lower board 53 such that the second locking pin 85 may be inserted and secured in the locking hole 53a.

A loop 86 is provided on top of the locking pin 85 so that a wire 91 connected to the manipulating lever 93 installed at the driver's seat is fastened to the loop 86. When the wire 91 fastened to the loop 86 is pulled by the manipulation of the manipulating lever 93, the second locking pin 85 is removed from the locking hole 53a of the lower board 53, so that the folding of each fork 60 is possible.

Meanwhile, the first and second locking means 100 and 80 are mechanically or automatically controlled.

As shown in FIG. 13, the wires 90 and 91 connected to the first and second locking means 100 and 80 are connected to the manipulating lever 93 installed near the driver's seat. Thus, when a user sitting on the driver's seat manipulates the manipulating lever 93 to pull the wires 90 and 91, the first locking pin 104 of the first locking means 100 is fitted into the fitting groove 52, and the second locking pin 85 of the second locking-means 80 is removed from the locking hole 53a of the lower board 53. Thereby, the folding of each fork 60 is possible.

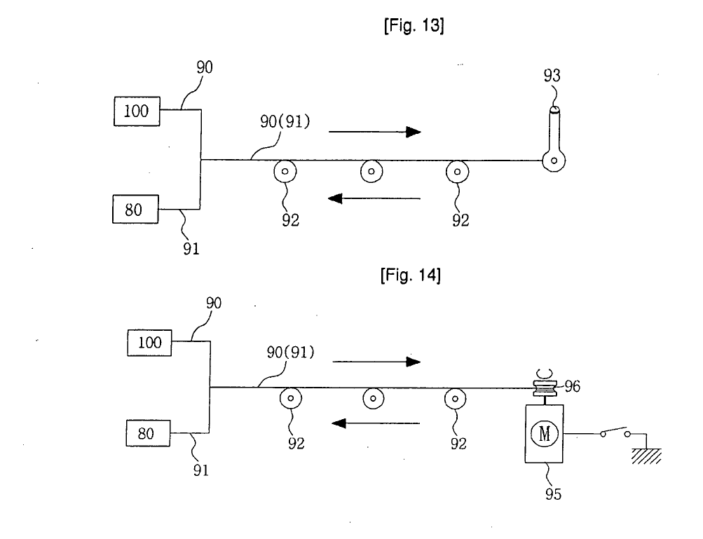

Further, as shown in FIG. 14, an additional on/off manipulating switch 97 may be installed on the driver's seat, and a motor 95 which is rotated forwards or backwards in conjunction with the on/off manipulating switch 97 may be provided. A winding roller 96, around which one end of each wire 90, 91 is wound, is mounted to a driving shaft of the motor 95. Further, the other end of each wire 90, 91 is respectively connected to the first and second locking means 100 and 80. Thus, as a driver turns on the manipulating switch 97 while sitting on the driver' seat, the motor 95 rotates in one direction to rotate the winding roller 96, thus pulling the wire 90, 91. Thereby, the first and second locking means 100 and 80 are operated, so that the folding of each fork 60 is possible.

When the wires 90 and 91 extending from the locking means 100 and 80 are connected to the manipulating lever 93 of the driver's seat or the winding roller 96, the wires are guided by a plurality of guide rollers 92 which are installed at several positions on the forklift truck. Thus, the wires are connected and kept taut.

The embodiment of this invention constructed as described above is operated as follows. That is, as a user manipulates the manipulating lever 93 or the manipulating switch 97, which are installed near the driver's seat, the wires 90 and 91 are pulled. Thus, the first locking pin 104 is fitted into the fitting groove 52 of the shaft 50, and the second locking pin 85 is dislodged from the locking hole 53a of the lower board 53, so that the folding of each fork 60 is possible. In such a state, when the driver manipulates another switch (not shown) to rotate the hydraulic motor 56 at 90 degrees, the shaft 50 is rotated at 90 degrees by the driving of the hydraulic motor 56. Thus, each coupling pipe 54 to which the first locking pin 104 is locked is rotated along with the shaft 50, so that each fork 60 is rotated at 90 degrees along with the shaft 50. Thereby, the forks 60 are folded upwards, as shown in FIG. 9.

As described above, when each fork 60 is rotated at 90 degrees and is folded upwards, the forklift truck may run on the road with the forks 60 folded toward the sky, thus ensuring safety.

Meanwhile, according to this invention, the interval between the forks 60 hooked to the shaft 50 may be adjusted.

To this end, external threaded parts 58 and 59 are formed on both sides of the outer circumferential surface of the shaft 50 such that threads of the external threaded parts 58 and 59 are formed in opposite directions. An internal threaded part 55 corresponding to the external threaded part 58, 59 is provided on the inner circumferential surface of each coupling pipe 54 which is fitted over the shaft 50. When the shaft 50 is rotated in one direction by the rotation of the hydraulic motor 56, the interval between the coupling pipes 54 fastened to the shaft 50 is increased or decreased, so that the interval between the forks 60 is automatically adjusted.

That is, the external threaded parts 58 and 59 are formed on the outer circumferential surface of the shaft 50 in opposite directions. Thus, when the shaft 50 rotates in one direction, the interval between the two coupling pipes 54 fitted over the shaft 50 is increased or decreased, so that the interval between the forks 60 is adjusted.

According to another embodiment of this invention, the forks are the weakest part. The present invention uses an elbow structure which has been widely applied to the forklift truck so as to ensure safety, thus affording safety. Unlike the conventional forklift truck which is constructed so that a hook part is welded to an end of the vertical part of each fork, the present invention is constructed so that the hook part provided on an end of the vertical part of each fork is bent in a ‘U’ shape, so that greater safety and strength are ensured.

Further, when a driver desires to fold the forks 60, he or she need not get out of the driver's seat. That is, the driver easily manipulates the manipulating lever 93 or the manipulating switch 97 while sitting on the driver's seat, thus converting the state of the forks 60 into the state permitting the forks 60 to be folded. In such a state, the forks 60 are folded, so that it is very convenient to fold the forks 60.

### INDUSTRIAL APPLICABILITY

As described above, the present invention provides an automatic folding fork device for forklift trucks, which is operated so that forks are rotated upwards and folded by the rotation of a hydraulic motor when a driver driving in a forklift truck easily manipulates a lever or switch, thus allowing the forklift truck to move safely, with the forks in a folded state, and which is constructed so that external threaded parts, having threads formed in opposite directions, are provided on both sides of the outer circumferential surface of a shaft, and coupling pipes having internal threaded parts corresponding to the external threaded parts are provided, thus allowing an interval between the forks mounted to the coupling pipes to be adjusted, according to the rotating direction of the hydraulic motor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An automatic folding fork device for a forklift truck having a pair of forks mounted to a carriage which moves up and down along mast rails, wherein a shaft is inserted in and secured to a midsection of the carriage, with a fitting groove being concavely formed in an upper surface of the shaft in a longitudinal direction thereof, and a hydraulic motor is provided on a side of the carriage to rotate the shaft forwards or backwards, and a plurality of coupling pipes is secured to the shaft at regular intervals, and a ‘U’-shaped hook part is provided on an end of a vertical part of each of the forks and is hooked to an associated coupling pipe, and
a fastening pin is inserted into an upper portion of the hook part to fasten each of the coupling pipes to the hook part, and pin locking means is provided to a side of each of the coupling pipes and is provided with a locking pin which is fitted into the fitting groove by a user's manipulation.

2. The automatic folding fork device according to claim 1, wherein the pin locking means comprises:
a housing provided at a predetermined position on each of the coupling pipes, and having a ‘U’-shaped cross-section, pin locking ribs being provided on upper and lower portions of the housing and a nut mounting space being defined between the pin locking ribs;
the locking pin having a pin shank which passes through the pin locking ribs in a direction from a lower position to an upper position; and
an adjusting nut secured to a middle portion of the pin shank, and allowing the locking pin to move up and down,
whereby the locking pin moves up and down according to the rotating direction of the adjusting nut, so that the locking pin is selectively fitted into the fitting groove.

3. The automatic folding fork device according to claim 1, wherein a pin hole is formed in an upper portion of the hook part so that the fastening pin is fitted into the pin hole, and a pin insertion recess is formed on each of the coupling pipes so that the fastening pin is inserted into the pin insertion recess.

4. The automatic folding fork device according to claim 1, wherein external threaded parts, having threads formed in opposite directions, are provided on both sides of an outer circumferential surface of the shaft, and an internal threaded part corresponding to each of the external threaded parts is provided on an inner circumferential surface of each of the coupling pipes which are fitted over the shaft, so that, when the shaft is rotated in one direction by rotation of the hydraulic motor, the coupling pipes secured to the shaft move away from each other or move near each other, thus automatically adjusting an interval between the forks.

5. An automatic folding fork device for a forklift truck having a pair of forks mounted to a carriage which moves up and down along mast rails, wherein a shaft is inserted in and secured to a midsection of the carriage, with a fitting groove being concavely formed in an upper surface of the shaft in a longitudinal direction thereof, and a hydraulic motor is provided on a side of the carriage to rotate the shaft forwards or backwards, and a plurality of coupling pipes is secured to the shaft at regular intervals, and a ‘U’-shaped hook part is provided on an end of a vertical part of each of the forks and is hooked to an associated coupling pipe, and
a fastening pin is inserted into an upper portion of the hook part to fasten each of the coupling pipes to the hook part, first locking means is provided on a side of each of the coupling pipes and is provided with a first locking pin which is fitted into the fitting groove by a user's manipulation to lock the coupling pipe to the shaft, and second locking means is provided on a middle portion of the vertical part of each of the forks and is selectively fitted into a locking hole of a lower board to lock the fork to the lower board.

6. The automatic folding fork device according to claim 5, wherein the first locking means comprises:
a housing provided at a predetermined position on a lower end of each of the coupling pipes, and comprising a pin receiving space to receive the first locking pin therein, with a pin hole being formed above the pin receiving space;
the first locking pin provided in the housing and elastically biased by a return spring in a direction in which the first locking pin is removed from the fitting groove;
a wire connection bar having a predetermined length, and protruding from the locking pin; and
a wire connected to both the wire connection bar and a manipulating lever installed near a driver's seat.

7. The automatic folding fork device according to claim 5, wherein the second locking means comprises:
a horizontal bar having a predetermined length, and provided on a rear surface on a middle portion of the vertical part of each of the forks in such a way as to be positioned above the lower board;
a cover protruding from an upper surface of the horizontal bar, and having a wire outlet hole;
a second locking pin provided inside the cover to be elastically biased by a return spring in a direction where the second locking pin moves downwards;
the locking hole formed in the upper surface of the lower board; and a loop provided on top of the locking pin so that a wire connected to the manipulating lever is fastened to the loop.

8. The automatic folding fork device according to claim 5, further comprising: a manipulating switch provided at the driver's seat;
a motor rotating forwards or backwards in response to an ON/OFF operation of the manipulating switch; and
a winding roller mounted to a driving shaft of the motor, the wires connected to the first and second locking means being wound around the winding roller.

9. The automatic folding fork device according to claim 5, wherein a pin hole is formed in an upper portion of the hook part so that the fastening pin is fitted into the pin hole, and a pin insertion recess is formed on each of the coupling pipes so that the fastening pin is inserted into the pin insertion recess.

10. The automatic folding fork device according to claim 5, wherein external threaded parts, having threads formed in opposite directions, are provided on both sides of an outer circumferential surface of the shaft, and an internal threaded part corresponding to each of the external threaded parts is provided on an inner circumferential surface of each of the coupling pipes which are fitted over the shaft, so that, when the shaft is rotated in one direction by rotation of the hydraulic motor, the coupling pipes secured to the shaft move away from each other or move near each other, thus automatically adjusting an interval between the forks.
